(19) United States
(12) Patent Application Publication
(10) Pub. No.: US 2025/0050266 A1
(43) Pub. Date: Feb. 13, 2025

(54) System and Method for Removing Acid Gas from Syngas with Heat Recovery

(71) Applicant: SABIC GLOBAL TECHNOLOGIES B.V., Bergen op Zoom (NL)

(72) Inventors: Jagan Mohan Rallapalli, Riyadh (SA); Ameen S. Ghamdi-AI, Riyadh (SA); Abdullah Saad AI-Dughaither, Riyadh (SA); Ramzi AI-Shaikh, Jubail (SA); Ahmed Saad AI-Bawayet, Jubail (SA)

(21) Appl. No.: 18/719,571

(22) PCT Filed: Dec. 8, 2022
(86) PCT No.: PCT/EP2022/085047

§ 371 Date: Jun. 13, 2024

(30) Foreign Application Priority Data
Dec. 15, 2021 (EP) 21214844.9

(51) Int. Cl. B01D 53/14; B01D 53/18; C01B 3/52

(52) U.S. Cl. CPC B01D 53/1475; B01D 53/1425; B01D 53/1493; B01D 53/18; C01B 3/52; B01D 2252/204; B01D 2257/504; B01D 2259/65; C01B 2203/0415; C01B 2203/0475; C01B 2203/0883

(57) ABSTRACT

The invention provides a system for removing an acid gas from syngas with enhanced heat recovery, the system including an acid gas absorber containing a solvent and having an inlet positioned to receive a syngas stream, the acid gas absorber producing an acid gas enriched solvent effluent; a first heat exchanger positioned to exchange heat between the syngas stream upstream of the acid gas absorber and the acid gas enriched solvent effluent; and an acid gas stripper positioned to receive the acid gas enriched solvent effluent from the first heat exchanger, the acid gas stripper producing a lean solvent effluent having reduced acid gas content. The invention also provides a method for removing an acid gas from syngas with enhanced heat recovery, which involves heating an acid gas enriched solvent effluent through heat exchange with a syngas stream upstream of an acid gas absorber.

### TECHNOLOGICAL FIELD

The present disclosure relates to a system and method for removing an acid gas from syngas with enhanced heat recovery.

### BACKGROUND

Synthesis gas (or syngas) can be readily produced from a carbon source, such as either coal or methane, by methods well known in the art. Numerous industrial processes convert syngas into various hydrocarbon products and oxygenated organic chemicals. For example, the Fischer-Tropsch catalytic process is adapted for catalytically producing hydrocarbons from syngas, with example products ranging from gasoline-range hydrocarbon liquids having six or more carbon atoms, along with other heavier hydrocarbon products, as well as lower molecular weight C2-C4 hydrocarbons. In another example, 2-ethyl hexanol (2-EH), which is primarily used as feedstock in the production of plasticizers and lubricants, is produced in a multi-step process using syngas and propylene as starting materials. See, for example, the 2-EH synthesis processes set forth in US2020/0262772 and US20210221759, both to Rallapalli et al.

Carbon dioxide (CO₂) is produced in the process of producing syngas from a carbon source, such as natural gas. It is generally desirable to remove as much carbon dioxide as possible from syngas prior to its downstream use in various synthesis reactions, such as 2-EH production processes. The carbon dioxide is then available for recycle back to the syngas production unit.

Certain known processes for removing carbon dioxide from syngas involve use of a system that includes an acid gas absorber, which absorbs carbon dioxide into a solvent, and an acid gas stripper, which removes carbon dioxide from the solvent to regenerate the solvent for reuse. See, for example, such a system set forth in US2019/0308876 to Ahmed.

There remains a need in the art for improved systems and methods for removing an acid gas, such as carbon dioxide, from a syngas with efficient heat recovery.

### BRIEF SUMMARY

The present disclosure provides a system and method for removing an acid gas from syngas with enhanced heat recovery, which involves heating an acid gas enriched solvent effluent through heat exchange with a syngas stream upstream of an acid gas absorber. The use of such a heat exchange has numerous advantages, including effective recovery of part of the syngas reformer exit stream heat content, more efficient acid gas stripping from the acid gas enriched solvent effluent due to increased temperature at the inlet of an acid gas stripper, reduction in energy consumption in the acid gas stripper reboiler (with attendant reduced steam flow and condensate flow in the reboiler), and reduction in cooling water circulation (and attendant heat loss) required to cool syngas prior to acid gas absorption operation.

The present disclosure includes, without limitation, the following embodiments.

Embodiment 1: A system for removing an acid gas from syngas with enhanced heat recovery, comprising: an acid gas absorber containing a solvent and having an inlet positioned to receive a syngas stream, the acid gas absorber producing an acid gas enriched solvent effluent; a first heat exchanger positioned to exchange heat between the syngas stream upstream of the acid gas absorber and the acid gas enriched solvent effluent; and an acid gas stripper positioned to receive the acid gas enriched solvent effluent from the first heat exchanger, the acid gas stripper producing a lean solvent effluent having reduced acid gas content.

Embodiment 2: The system of Embodiment 1, further comprising a second heat exchanger positioned in fluid communication with the syngas stream downstream from the first heat exchanger and adapted to further cool the syngas stream upstream of the acid gas absorber.

Embodiment 3: The system of Embodiment 1 or 2, further comprising a third heat exchanger positioned to exchange heat between the lean solvent effluent and the acid gas enriched solvent effluent, the third heat exchanger being positioned to preheat the acid gas enriched solvent effluent upstream of the first heat exchanger.

Embodiment 4: The system of any one of Embodiments 1 to 3, wherein the solvent comprises an amine.

Embodiment 5: The system of any one of Embodiments 1 to 4, wherein the acid gas enriched solvent effluent enters the acid gas stripper at a temperature of greater than 115° C., and/or the syngas stream enters the acid gas absorber at a temperature of about 45 to about 55° C.

Embodiment 6: The system of any one of Embodiments 1 to 5, wherein the syngas stream comprises carbon dioxide and the acid gas absorber is adapted to remove carbon dioxide from the syngas stream.

Embodiment 7: The system of any one of Embodiments 1 to 6, wherein the syngas stream has an H₂/CO molar ratio of about 0.5 to about 3.0 and/or a carbon dioxide concentration of about 6 mol % to about 15 mol % on wet basis.

Embodiment 8: The system of any one of Embodiments 1 to 7, wherein the lean solvent effluent is recycled to the acid gas absorber.

Embodiment 9: A method for removing an acid gas from syngas with enhanced heat recovery, comprising: treating a syngas stream with a solvent in an acid gas absorber to reduce acid gas content of the syngas stream, producing an acid gas enriched solvent effluent; heating the acid gas enriched solvent effluent through heat exchange with the syngas stream upstream of the acid gas absorber, producing a heated acid gas enriched solvent effluent and a cooled syngas stream; treating the heated acid gas enriched solvent effluent in an acid gas stripper, producing a lean solvent effluent having reduced acid gas content; and optionally recycling the lean solvent effluent to the acid gas absorber.

Embodiment 10: The method of Embodiment 9, further comprising cooling the cooled syngas stream through a second heat exchange prior to treating the syngas stream in the acid gas absorber.

Embodiment 11: The method of Embodiment 9 or 10, further comprising preheating the acid gas enriched solvent effluent through heat exchange with the lean solvent effluent upstream of the heat exchange with the syngas stream.

Embodiment 12: The method of any one of Embodiments 9 to 11, wherein the solvent comprises an amine.

Embodiment 13: The method of any one of Embodiments 9 to 12, wherein the acid gas enriched solvent effluent enters the acid gas stripper at a temperature of greater than 115° C. and/or the syngas stream enters the acid gas absorber at a temperature of about 45 to about 55° C.

Embodiment 14: The method of any one of Embodiments 9 to 13, wherein the syngas stream comprises carbon dioxide and the acid gas absorber is adapted to remove carbon dioxide from the syngas stream.

Embodiment 15: The method of any one of Embodiments 9 to 14, wherein the syngas stream has an H₂/CO molar ratio of about 0.5 to about 3.0 and/or a carbon dioxide concentration of about 6 mol % to about 15 mol % on wet basis.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE

Having thus described aspects of the disclosure in the foregoing general terms, reference will now be made to the accompanying figure, which is not necessarily drawn to scale, and wherein:

FIG. 1 is a simplified schematic diagram of an example acid gas recovery system in accordance with the present disclosure.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like. As used in the specification and the appended claims, the singular forms “a,” “an,” and “the” include plural referents unless the context clearly dictates otherwise. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.).

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true.

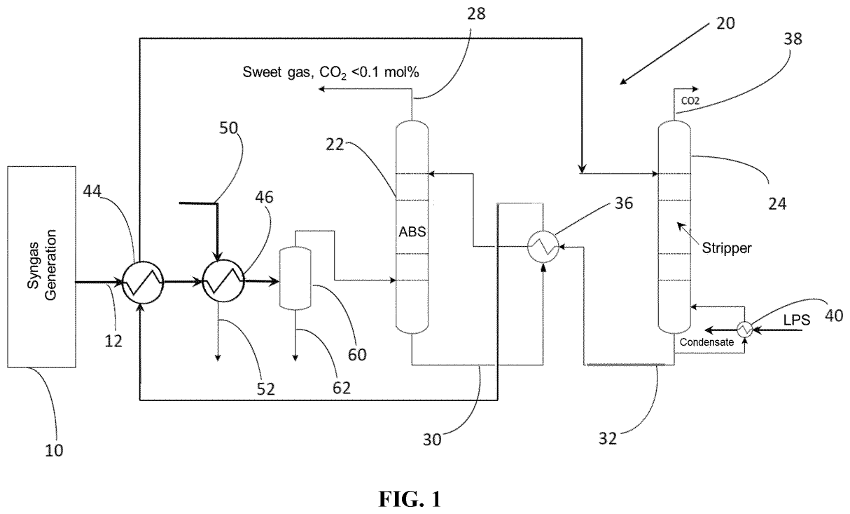

The system and method of the present disclosure is adapted for efficient removal of acid gas, such as carbon dioxide, from syngas with efficient redistribution of heat within the system. Typically, as shown in FIG. 1, syngas will be produced in a syngas generation unit 10. The manner in which the syngas is produced can vary without departing from the present disclosure.

In certain embodiments, the syngas generation unit 10 is configured to receive a carbon source, for example, natural gas, that can be converted to syngas in the syngas generation unit. It is understood that the syngas can be generated from a variety of different materials that contain carbon. For example, the syngas can be generated from biomass, plastics, coal, municipal waste, natural gas, other fuel sources including methane, or any combination thereof. In certain embodiments, syngas generation from the fuel comprising methane can be based on steam reforming, autothermal reforming, partial oxidation, or any combination thereof. Accordingly, the syngas generation unit 10 can be a steam syngas generation unit, an autothermal syngas generation unit, a dry methane reforming unit, or a partial oxidation syngas generation unit.

In one embodiment, the syngas is generated by steam reforming, such as by steam methane (e.g., natural gas) reforming using an external source of hot gas to heat tubes in which a catalytic reaction takes place that converts steam and methane into a gas comprising hydrogen and carbon monoxide. In another embodiment, the syngas is generated by autothermal reforming, such as wherein methane is partially oxidized in the presence of oxygen and carbon dioxide or steam. In embodiments where oxygen and carbon dioxide are used to generate syngas from methane, the hydrogen and carbon monoxide can be produced in a ratio of, for example, 1 to 1. In embodiments where oxygen and steam are utilized, the hydrogen and carbon monoxide can be produced in a ratio of, for example, 2.5 to 1.

In a further embodiment, the syngas is generated by reacting CO₂ with methane, with a CO₂:CH₄ molar ratio of 3:2 in the feed typically used in the syngas generation unit 10, thereby creating a CO-rich syngas. Sometimes, steam will also be added to above syngas generation unit 10 to maintain the lower methane content in the syngas.

In another embodiment, the syngas is generated by a partial oxidation, such as wherein a sub-stoichiometric fuel-air mixture is partially combusted in the syngas generation unit 10, creating a hydrogen-rich syngas. The partial oxidation can comprise, for example, thermal partial oxidation and catalytic partial oxidation. An example thermal partial oxidation is dependent on the air-fuel ratio and proceeds at temperatures of 1,200° C. or higher. An example catalytic partial oxidation uses a catalyst that allows reduction of the required temperature to about 800° C. to 900° C. It is further understood that the choice of a reforming technique can depend on the sulfur content of the fuel being used. The catalytic partial oxidation can be employed if the sulfur content is below 50 ppm. A higher sulfur content can poison the catalyst, and thus, other reforming techniques can be utilized.

The product that is generated in the syngas generation unit 10 also contains an acid gas such as CO₂. Thus, the product that exits the syngas generation unit 10 comprises at least syngas and CO₂. In one aspect, the product that exits the syngas generation unit comprises up to 20 mol % of CO₂ on a wet basis. For example, the product that exits the syngas generation unit can comprise from about 1 mol % to about 20 mol % of CO₂, such as from about 6 mol % to about 15 mol % of CO₂.

The syngas that that is produced in the syngas generation unit can have a H₂/CO molar ratio from about 0.5 to about 4 (e.g., about 0.5 to about 3.0). In some embodiments, the H₂/CO molar ratio can be from about 1.0 to about 3.0, such as from about 1.5 to about 3.0 or from about 1.5 to about 2.5. In one embodiment, the syngas stream has a composition of about 40-45 mol % hydrogen, about 12-20 mol % carbon monoxide, about 6-10 mol % carbon dioxide, about 28-34 mol % water vapor, and less than about 5 mol % nitrogen.

The syngas stream 12 that exits the syngas generation unit 10, comprising at least syngas and CO₂, enters the acid gas removal system 20 for removal of at least a portion of the CO₂ that is present in the syngas. The acid gas removal system 20 includes an acid gas absorber 22 and an acid gas stripper 24. If necessary, the acid gas removal system 20 can include multiple acid gas absorbers and multiple acid gas strippers positioned in series or parallel, without departing from the present disclosure.

An acid gas absorber 22 can absorb CO₂ by dissolving CO₂ in a suitable liquid solvent. This absorption can then be reversed in the acid gas stripper 24 to release the CO₂ from the solvent, which solvent can then be reused in the acid gas absorber to further capture CO₂ in the same manner.

The use of this absorption and stripping process with aqueous solvents such as alkanolamines and promoted potassium carbonate is known in the art. For example, CO₂ or other acid gases, such as hydrogen sulfide, can be removed from flue gas, natural gas, hydrogen, synthesis gas, and other gases as described in U.S. Pat. No. 4,477,419 to Pearce et al.; U.S. Pat. No. 4,384,875 to Batteux et al.; and U.S. Pat. No. 4,152,217 to Eisenberg et al., each of which is incorporated herein by reference, in particular for their disclosure of carbon dioxide absorption and stripping.

In one aspect, an alkanolamine can be used in the absorption/stripping process. For example, an aqueous solution of monoethanolamine (MEA) or diethanolamine (DEA) can be used. In another example, solvent blends can be use, such as, for example, a blend of a methyldiethanolamine (MDEA) solution promoted by piperazine or other secondary amines. Also, potassium carbonate solvents can be promoted by DEA or other reactive amines.

In the absorption stage, the gas to be treated, containing the CO₂ to be removed, is placed in contact, in an absorption column (e.g., acid gas absorber 22), with the chosen solvent under conditions of pressure and temperature such that the absorbent solution removes virtually all the CO₂. In certain embodiments, the syngas stream 12 enters the acid gas absorber 22 at a temperature of about 45 to about 55° C.

The purified syngas (also referred to as “sweet gas”) 28 exits the acid gas absorber 22 and is processed downstream as desired, such as reaction of the syngas to produce 2-EH. The sweet gas stream typically has less than 0.1 mol % CO₂. The absorbent solvent containing CO₂ (also called “rich solvent”) stream 30 is drawn off and subjected to a stripping process in acid gas stripper 24 to free it of the CO₂ and regenerate the solvent's absorbent properties, thus producing a CO₂-depleted solvent stream 32 (also called “lean solvent”).

The stripping process, which takes place in the acid gas stripper 24, of the rich solvent stream 30 can be done at, for example, 100-120° C. at 1-2 atm to release the CO₂ and produce the lean solvent stream 32. The rich solvent stream 30 can be optionally preheated by cross-exchange with the hot lean solvent stream 32 to within, for example, 5-30° C. of the acid gas stripper bottoms using a heat exchanger 36. The overhead vapor product stream 38 from the stripper 24 is typically cooled to condense water, which can be returned as reflux to the countercurrent stripper (not shown). Once stripped, the CO₂ can be compressed to, for example, 10-150 atm for further use. The acid gas stripper 24 typically includes a reboiler 40 that can heat a portion of the stripper bottoms for return to the stripper. The reboiler 40 typically receives a hot fluid stream, such as low pressure steam (LPS), which is condensed into a condensate stream that is withdrawn from the reboiler.

In one embodiment, both the acid gas absorber 22 and the acid gas stripper 24 can have, for example, a volume of at least about 1,000 liters, about 2,000 liters, about 5,000 liters, or about 20,000 liters. For example, both the acid gas absorber 22 and the acid gas stripper 24 can have a volume from about 1,000 liters to about 20,000 liters.

In the present disclosure, typically following preheating of the rich solvent stream 30 by cross-exchange with the regenerated lean solvent stream 32, the rich solvent stream is heated further by cross-exchange with the syngas inlet stream 12 into the acid gas removal system 20 using a heat exchanger 44. This enhances energy efficiency in the acid gas removal system 20 by, for example, increasing the temperature of the rich solvent stream 40 at the inlet of the acid gas stripper 24, which improves the stripping performance of the stripper while reducing the heat duty on the stripper reboiler 40. In certain embodiments, the rich solvent stream 30 enters the acid gas stripper 24 at a temperature of greater than about 115° C., such as about 115 to about 120° C.

In addition, by removing some of the heat energy from the syngas stream 12 using the cross-exchange heat exchanger 44, reduced heat duty is needed to further cool the syngas stream 12 prior to entering the acid gas absorber 22. For example, the acid gas removal system typically includes a further downstream heat exchanger 46 that uses a cooling fluid, such as cooling water, to further reduce the temperature of the syngas stream 12. As shown in FIG. 1, the heat exchanger 46 can receive a cooling water inlet stream 50 and produce a cooling water outlet stream 52. The heat duty for this second heat exchanger 46 can be reduced as a result of the upstream heat exchanger 44. Optionally, downstream from the cooling water heat exchanger 44, the syngas stream 12 can pass through a condenser 60 to remove any condensate (e.g., water) from the syngas, thereby producing a condensate effluent 62.

Note that the syngas generation system 10 can include one or more heat exchangers in series upstream of heat exchanger 44 to cool the syngas stream 12 (not shown). For example, various other fluid streams utilized in a typical 2-EH production facility can be used to cool the syngas stream leaving the reformer, such as one or more of medium pressure steam, boiler water, and the like.

Any of the heat exchangers utilized in the disclosed acid gas removal system 20 can vary in style and design. In certain embodiments, each of the heat exchangers are shell and tube heat exchangers with characteristics as defined by the Tubular Exchanger Manufacturers Association (TEMA). Example configurations include BEM heat exchangers, which have an integral bonnet front end head, a one-pass shell, and a fixed tube sheet with stationary rear head. However, other configurations could be used, such as those with two-pass configurations, split flows, floating heads, and floating tubesheets.

The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure. Many modifications and other implementations of the disclosure will come to mind to one skilled in the art to which this disclosure pertains having the benefit of the teachings presented in the foregoing descriptions and the associated figures. Therefore, it is to be understood that the disclosure is not to be limited to the specific implementations disclosed herein and that modifications and other implementations are intended to be included within the scope of the appended claims. Although specific terms are employed herein, they are used in a generic and descriptive sense only and not for purposes of limitation.

### EXPERIMENTAL

A 2-EH plant was modeled using the system configuration of FIG. 1 to illustrate the enhanced energy efficiency of the present disclosure. In particular, the system of FIG. 1 was modeled using a theoretical inlet syngas stream 12 of 32.3 T/hr having a CO2 mol % in the syngas of 9.2 and a syngas temperature entering the acid gas removal system 20 of 131° C. Under those initial syngas conditions, the results set forth in Table 1 below are achieved when the FIG. 1 system with cross-exchange between the syngas inlet and the rich solvent stream is compared to a hypothetical system with no such cross-exchange (but otherwise the same).

TABLE 1

| | No Syngas/Rich | |
|---|---|---|
| | Solvent | FIG. 1 |
| Description | Cross-Exchange | System |
| Syngas flowrate (T/hr) | 32.3 | 32.3 |
| Syngas temperature - inlet to | 131 | 114.5 |
| Exchanger 46 in FIG. 1 (° C.) | | |
| Syngas temperature - outlet from | 51 | 51 |
| Heat Exchanger 46 in FIG. 1 (° C.) | | |
| Heat duty of Heat Exchanger 46 | 8.5 | 5.2 |
| in FIG. 1 (MW) | | |
| Cooling water flow to Heat | 787 | 500 |
| Exchanger 46 in FIG. 1 (T/hr) | | |
| Rich solvent temperature - inlet to | 100 | 120 |
| Stripper 24 (° C.) | | |
| Stripper 24 LP steam | 13.1 | 10.7 |
| consumption (T/hr) | | |
| 2-EH plant specific energy intensity | 0 | 0.25 |
| reduction (MMBTU/Ton 2-EH) | | |
| New Heat Exchanger 44 in FIG. 1 | NA | Yes |
| Heat duty (MW) | NA | 3.5 |
| Heat transfer area, m² | NA | 485.5 |
| TEMA Type of Heat Exchanger | NA | BEM |

As shown above, use of the cross-exchange between the syngas inlet and the rich solvent stream increases the temperature of the rich solvent as it enters the acid gas stripper, which enhances efficiency of the stripping operation and reduces the heat duty on the stripper reboiler (as shown by reduced stripper LP steam consumption). The heat duty and cooling water flow to Heat Exchanger 46 is also reduced, thereby reducing heat dissipated to the atmosphere through use of a cooling water tower. Although new Heat Exchanger 44 adds modest heat duty to the system, the overall impact of the system configuration of FIG. 1, when used as part of a 2-EH production process, is a reduction in energy consumption as expressed in terms of MMBTU/Ton 2-EH.

1. A system for removing an acid gas from syngas with enhanced heat recovery, comprising:
an acid gas absorber containing a solvent and having an inlet positioned to receive a syngas stream, the acid gas absorber producing an acid gas enriched solvent effluent;
a first heat exchanger positioned to exchange heat between the syngas stream upstream of the acid gas absorber and the acid gas enriched solvent effluent; and
an acid gas stripper positioned to receive the acid gas enriched solvent effluent from the first heat exchanger, the acid gas stripper producing a lean solvent effluent having reduced acid gas content.

2. The system of claim 1, further comprising a second heat exchanger positioned in fluid communication with the syngas stream downstream from the first heat exchanger and adapted to further cool the syngas stream upstream of the acid gas absorber.

3. The system of claim 1, further comprising a third heat exchanger positioned to exchange heat between the lean solvent effluent and the acid gas enriched solvent effluent, the third heat exchanger being positioned to preheat the acid gas enriched solvent effluent upstream of the first heat exchanger.

4. The system of claim 1, wherein the solvent comprises an amine.

5. The system of claim 1, wherein the acid gas enriched solvent effluent enters the acid gas stripper at a temperature of greater than 115° C., and/or the syngas stream enters the acid gas absorber at a temperature of about 45 to about 55° C.

6. The system of claim 1, wherein the syngas stream comprises carbon dioxide and the acid gas absorber is adapted to remove carbon dioxide from the syngas stream.

7. The system of claim 1, wherein the syngas stream has an H₂/CO molar ratio of about 0.5 to about 3.0 and/or a carbon dioxide concentration of about 6 mol % to about 15 mol %.

8. The system of claim 1, wherein the lean solvent effluent is recycled to the acid gas absorber.

9. A method for removing an acid gas from syngas with enhanced heat recovery, comprising:
treating a syngas stream with a solvent in an acid gas absorber to reduce acid gas content of the syngas stream, producing an acid gas enriched solvent effluent;
heating the acid gas enriched solvent effluent through heat exchange with the syngas stream upstream of the acid gas absorber, producing a heated acid gas enriched solvent effluent and a cooled syngas stream;
treating the heated acid gas enriched solvent effluent in an acid gas stripper, producing a lean solvent effluent having reduced acid gas content; and optionally recycling the lean solvent effluent to the acid gas absorber.

10. The method of claim 9, further comprising cooling the cooled syngas stream through a second heat exchange prior to treating the syngas stream in the acid gas absorber.

11. The method of claim 9, further comprising preheating the acid gas enriched solvent effluent through heat exchange with the lean solvent effluent upstream of the heat exchange with the syngas stream.

12. The method of claim 9, wherein the solvent comprises an amine.

13. The method of claim 9, wherein the acid gas enriched solvent effluent enters the acid gas stripper at a temperature of greater than 115° C. and/or the syngas stream enters the acid gas absorber at a temperature of about 45 to about 55° C.

14. The method of claim 9, wherein the syngas stream comprises carbon dioxide and the acid gas absorber is adapted to remove carbon dioxide from the syngas stream.

15. The method of claim 9, wherein the syngas stream has an H₂/CO molar ratio of about 0.5 to about 3.0 and/or a carbon dioxide concentration of about 6 mol % to about 15 mol %.
